(19) United States
(12) Patent Application Publication
(10) Pub. No.: US 2026/0268457 A1
(43) Pub. Date: Sep. 10, 2026

(54) METHOD FOR NOISE REDUCTION IN INPUT IMAGE DATA

(71) Applicant: Siemens Healthineers AG, Forchheim (DE)

(72) Inventors: Stefan Böhm, Oberasbach (DE); Uwe Fabricius, Erlangen (DE)

(21) Appl. No.: 19/545,380

(22) Filed: Feb. 20, 2026

(30) Foreign Application Priority Data
Mar. 6, 2025 (EP) 25162054

(51) Int. Cl. G06T 5/70; G06T 5/60

(52) U.S. Cl. CPC G06T 5/70; G06T 5/60

(57) ABSTRACT

A computer-implemented method for noise reduction in input image data includes generating, via applying a first noise reduction algorithm, first noise-reduced image data that has a first noise-reduced image point value for each image point of a plurality of image points, wherein the application of the first noise reduction algorithm involves an application of a trained machine learning model to input data dependent upon the input image data. The method further includes checking an image content of the input image data; and generating resultant image data based on the input image data, wherein the resultant image data for each image point has a resultant image point value, and wherein each resultant image point value is given by a combination, dependent upon a result of the checking, of the respective first noise-reduced image point value and a respective further image point value.

The present patent document claims the benefit of European Patent Application No. 25162054, filed Mar. 6, 2025, which is hereby incorporated by reference in its entirety.

### TECHNICAL FIELD

The present disclosure relates to a computer-implemented method for noise reduction in input image data generated by an imaging system. The disclosure also relates to a corresponding imaging method, a corresponding data processing system, an imaging apparatus, and a computer program product.

### BACKGROUND

Input image data generated by an imaging system may have noise, for example, an inherent quantum noise, due to an imaging process. In the case, for example, of input image data that has been generated with the aid of a radiation source, an image quality of the input image data for an individual image of the input image data may deteriorate with decreasing applied dose from the radiation source. It is an aim of modern image enhancement methods to reduce the noise while, as far as possible, simultaneously maintaining the useful information, for example, in the form of a signal or a structure being represented.

Noise reduction methods on the basis of artificial intelligence (AI), that is to say, methods in which, for example, a trained machine learning model (MLM) is applied to the input image data, may be superior to conventional methods in many cases since they may recognize structures in the noise and separate the structures from the noise. The lower an existing image quality is, characterized, for example, by a low signal-to-noise ratio (SNR), the more the AI-based noise reduction method succeeds in recognizing the structures only by way of strongly interpretive recognition. This may have the result that apparent structures in the noise are recognized as a useful signal, amplified and represented, although in fact they are not real structures, but only noise. This phenomenon may be related to the phenomenon of hallucination that is known in MLM technologies. This type of hallucination is visually perceptible, for example, in moving image series, such as, for example, in image series that are generated in the context of a fluoroscopy. The apparent structures may then change from image to image and may be disturbing for an observer. As a result, the AI-based noise reduction method cannot be used to its fullest extent effectively.

AI-based image processing methods are known from the prior art, for example, from the publication by S. Hariharan et al., “Learning-based X-ray Image Denoising Utilizing Model-based Image Simulations,” in Shen, D., et al., “Medical Image Computing and Computer Assisted Intervention-MICCAI 2019,” MICCAI 2019, Lecture Notes in Computer Science, vol. 11769, Springer, Cham, and from the publication by O. Ronneberger et al., “U-Net: Convolutional Networks for Biomedical Image Segmentation,” arXiv: 1505.04597.

### SUMMARY AND DESCRIPTION

It is an object of the present disclosure to improve a noise reduction in input image data generated by an imaging system with regard to the described disadvantages.

The scope of the present disclosure is defined solely by the appended claims and is not affected to any degree by the statements within this summary. The present embodiments may obviate one or more of the drawbacks or limitations in the related art.

The disclosure includes, for noise reduction for individual image points, combining a respective noise-reduced image point value with another image point value, wherein the combination is carried out dependent upon the image content of the input image data.

According to one aspect of the disclosure, a computer-implemented method is provided for noise reduction in input image data generated by an imaging system. On the basis of the input image data, first noise-reduced image data is generated by using a first noise reduction algorithm that has a first noise-reduced image point value for each image point of a plurality of image points. The application of the first noise reduction algorithm therein involves an application of a machine learning model (MLM), in particular, a trained MLM, for example, an MLM trained for noise reduction, on input data dependent upon the input image data. In addition, an image content of the input image data is checked according to a predetermined checking rule. Furthermore, resultant image data is generated on the basis of the input image data, wherein the resultant image data for each image point of the plurality of image points has a resultant image point value. Therein, for each image point of the plurality of image points, the resultant image point value is given by a combination, dependent upon a result of the checking, of the respective first noise-reduced image point value and a respective further image point value that is dependent upon the input image data.

If not otherwise stated, all the acts of the computer-implemented method may be carried out by a data processing system that has at least one data-processing device, in particular, by a data processing system of an imaging apparatus. In particular, the at least one data processing device is configured or adjusted for carrying out the acts of the computer-implemented method. For this purpose, the at least one data processing device may store, for example, a computer program containing commands that, when executed by the at least one data processing device, cause the at least one data processing device to carry out the computer-implemented method. The expressions “data processing system” and “at least one data processing device” may be used interchangeably.

In the event that the at least one data processing device contains two or more data processing devices, certain acts performed by the at least one data processing device may also be understood, for example, to mean that different data processing devices carry out different acts or different portions of an act. In particular, it is not required that each data processing device carries out the acts completely. In other words, the execution of the acts may be distributed over the two or more data processing devices.

From each embodiment of the computer-implemented method, there follows a corresponding embodiment of a method for noise reduction that is not purely computer-implemented in that corresponding acts for generating the resultant image data are included.

For example, though not necessarily, the input image data items for the plurality of image points each have an input image point value. In particular, however, it is not necessarily required that for each image point of the input image data, one or exactly one noise-reduced image point value also exists in the noise-reduced image data. This may possibly not be the case if the first noise reduction algorithm contains a change in the resolution (“upsampling/downsampling”), the first noise reduction algorithm is not applied to particular image regions of the input image data, for example, edge regions, the application of the first noise reduction algorithm is restricted to particular image regions of the input image data and suchlike. A similar principle applies in an analogue manner to the other image point values.

For example, the respective further image point value may be dependent upon the respective input image point value.

The input image data may correspond, for example, to one or more datasets that represent individual images or image series. In particular, the input image data may contain video data. In particular, the input image data may contain two-dimensional image data or three-dimensional image data. In particular, a first individual image dataset of the input image data may contain the same plurality of image points, in particular, according to the same spatial arrangement, as a second individual image dataset of the input image data or as each further individual image dataset of the input image data.

An image point may be understood to be, for example, a pixel or a voxel. An input image point value, a first noise-reduced image point value and/or a further image point value may take, for example, a numerical value that represents a gray scale value or a color value at the site of the corresponding image point.

In particular, the input image data contains a higher degree of image noise than the first noise-reduced image data. A worsening of a recorded image by interference that has no relation to the image content may be referred to as image noise. The image noise may have different levels for each image point of the plurality of image points and, in particular, may deviate from an image point value of a structure that is actually to be represented. A signal-to-noise ratio may be utilized as a measure for the image noise. The image content may contain, in particular, the structure actually to be represented.

A trained MLM may be regarded as an algorithm, in particular, a computer-implemented algorithm that may simulate specific functions or, in a broader sense, functions made possible through human intellectual activity. A trained MLM may be referred to as a “trained function.” A trained MLM may be implemented in software and/or hardware.

When an MLM is trained, parameters of the MLM may be adjusted or updated. The training may take place supervised, semi-supervised or unsupervised. The training may also involve reinforcement learning or representation learning and/or other known training methods. In particular, the parameters of the MLM may be adjusted iteratively over a plurality of training acts. In particular, for training, a pre-defined loss function may be minimized. For adjusting the parameters, if the MLM is an artificial neural network (ANN), then for example, a backpropagation algorithm may be used.

An MLM may include, in particular, an ANN, a support vector machine, a k-means clustering algorithm, a decision tree or suchlike. In particular, an ANN may be or include a deep neural network and/or a convolutional neural network (CNN), in particular, a deep CNN and/or a recurrent neural network (RNN), in particular, a recurrent CNN and/or a transformer network and/or a generative adversarial network GAN.

In particular, the trained machine learning model may include an MLM trained for noise reduction. For this purpose, in particular, an MLM based upon one of the aforementioned architectures may be used.

The input data may contain the input image data or may be generated dependent upon the input image data through pre-processing.

The image content of the input image data may be represented in the input image data. In particular, the image content may be provided by the input image point values of the plurality of image points. Checking of the image content of the input image data may be carried out, for example, for each image point individually. For this purpose, for example, the respective input image point value or a variable established therefrom may be compared with a predetermined threshold value. Dependent upon the result of the comparison, the respective resultant image point value may then be generated.

It is also possible that the totality of the input image data or the totality of the input image point values of the plurality of image points is checked in accordance with the checking rule. It is also possible that, in accordance with the checking rule, particular defined portions or subregions of the plurality of image points are checked individually with regard to the individual image point values. For example, the plurality of image points may be divided into a plurality of windows or subregions and the windows or subregions may be individually checked with regard to the input image point values, in accordance with the checking rule.

The resulting image data may correspond, for example, to exactly one resultant individual image or individual image dataset. The plurality of image points in the resultant image data may represent, for example, the plurality of image points in the first individual image of the input image data, in particular, with regard to their number and spatial arrangement.

The combination of the respective first noise-reduced image point value and of the respective further image point value depends upon the result of the checking and therefore, in particular, upon the image content of the input image data. For example, for a first image point, dependent upon the image content of the input image data, the resultant image point value may represent the respective first noise-reduced image point value. Alternatively, or additionally, for a second image point, the resultant image point value may represent the corresponding respective further image point value. Similarly, for a third image point, the resultant image point value may contain a proportion of the respective first noise-reduced image point value and a proportion of the respective further image point value. Dependent upon the result of the checking, the combination may also represent one of the boundary cases that the combination for the respective image point is equal to the respective noise-reduced image point value or is equal to the further image point value.

Thereby, a noise reduction of a respective image point value may be realized dependent upon the image content of the input image data. In particular, a signal-to-noise ratio of the resultant image data may be higher or significantly higher than the signal-to-noise ratio of the input image data.

An advantage of the disclosure is that, dependent upon the image content, the noise reduction in the input image data may be carried out for each image point of the plurality of image points individually. In particular, thereby a possibility is created for eliminating weak points in the first noise reduction algorithm for increasing a quality of the resultant image data. In particular, thereby a hallucination that may occur when the trained machine learning model is applied may be reduced. Since the first noise reduction algorithm is applied to the input data that is dependent upon the input image data and subsequently the resultant image data is generated selectively, the method is flexible in a selection of the first noise reduction algorithm. In particular, the combination of the respective first noise-reduced image point value and the respective further image point value may be selected individually for each image point, as is particularly advantageous according to the checking rule dependent upon the image content for the respective use. In particular, the first noise reduction algorithm may be a spatial, that is to say time-independent, noise reduction algorithm.

According to at least one embodiment, on the basis of the input image data, by applying a second noise reduction algorithm, second noise-reduced image data may be generated. Therein, the second noise-reduced image data each have a second noise-reduced image point value for the plurality of image points. In addition, each further image point value is provided by the respective second noise-reduced image point value.

In particular, the second noise reduction algorithm may be configured conventionally, that is to say, without applying the trained machine learning model or a further trained machine learning model. For example, the second noise reduction algorithm may be a spatial and/or a temporal noise reduction algorithm. In particular, the second noise reduction algorithm may contain a temporal denoiser.

It may be advantageous, for example, dependent upon the image content of the input image data, to generate the resultant image data by applying the first noise reduction algorithm or to generate the resultant image data by applying the second noise reduction algorithm or to combine both noise reduction algorithms. In particular, by way of the combination, which is dependent upon the result of the checking, of the respective first noise-reduced image point value and the respective second noise-reduced image point value, the signal-to-noise ratio of the resultant image data may be increased.

According to at least one further embodiment, the trained machine learning model contains a convolutional neural network, for example, a U-Net or a network on the basis of the U-Net.

A use of the convolutional neural network has proved itself, in particular, in relation to image-to-image algorithms in the context of imaging methods and enables a particularly reliable and efficient noise reduction.

According to at least one further embodiment, on the basis of the input image data, by applying a variance-stabilizing transformation, variance-stabilized input image data is generated. The input data also depends upon the variance-stabilized input image data.

For example, the variance-stabilizing transformation may contain a generalized Anscombe transformation (GAT).

The input data may be provided, in particular, by way of the variance-stabilized input image data or may contain it. In particular, for each image point of the plurality of image points, the respective further image point value may also be dependent upon the variance-stabilized input image data.

The generation of the resultant image data may therein take place, in particular, by the application of an inverse variance-stabilizing transformation, for example, an inverse generalized Anscombe transformation (iGAT).

The application of the variance-stabilizing transformation may advantageously have its effect on a result of the noise reduction by way of the first noise reduction algorithm due to a stabilization and/or a normalization of a noise variance.

According to at least one further embodiment, according to the predetermined checking rule, the checking of the image content is carried out dependent upon the variance-stabilized input image data. The respective further image point value is dependent upon the variance-stabilized input image data.

For example, the variance-stabilized input image data has, for each image point of the plurality of image points, a variance-stabilized image point value. In particular, the respective further image point value is dependent upon the respective variance-stabilized image point value.

The application of the variance-stabilizing transformation may advantageously have its effect on a result of the noise reduction through the second noise reduction algorithm due to a stabilization and/or a normalization of a noise variance.

According to at least one further embodiment, the input image data has an individual image dataset that has, in particular, for each image point of the plurality of image points, the input image point value. Furthermore, the input image data has a further individual image dataset that has, in particular, for each image point of the plurality of image points, a further input image point value. In addition, the individual image dataset and the further individual image dataset follow one another temporally. Furthermore, according to the predetermined checking rule, the image content is checked dependent upon the individual image dataset and the further individual image dataset.

An individual image dataset may represent, for example, a two-dimensional individual image or a three-dimensional individual image, in particular, a three-dimensional image reconstruction. In other words, an individual image dataset may represent a frame.

In other words, the input image data may contain an image series in which the individual image dataset and the further individual image dataset have been recorded temporally sequentially. In particular, a structure to be represented may therein be represented both by the individual image dataset and also by the further individual image dataset. In the case of an unchanged and/or unmoving structure, the individual image dataset may differ from the further individual image dataset, for example, only in the image noise. In the case of a changed and/or moving structure, a difference in the corresponding image point value between the individual image dataset and the further individual image dataset may be greater than a difference that is brought about by image noise. The delimitation may take place by way of a suitably selected boundary value.

A cause of a changed and/or moving structure may be a movement of a mapped object, for example, a body of a patient or a portion of the body of the patient. In particular, a moving structure may also include a representation of an organ of the patient that is moved, for example, by breathing or a heartbeat.

An advantage of these embodiments is that by way of the temporally successive individual image datasets, an increased information content is available for the noise reduction in the input image data. In particular, a representation of a moving structure may thereby be distinguished from a representation of an unmoving structure.

According to at least one further embodiment, in accordance with the predetermined checking rule, dependent upon the individual image dataset and the further individual image dataset, for each image point of the plurality of image points, a deviation value is determined for a deviation of the individual image dataset from the further individual image dataset. Furthermore, the combination is dependent upon the respective deviation value.

In other words, the deviation value may be a measure for a deviation of the individual image dataset from the further individual image dataset, in particular, a locally delimited deviation. The deviation may therein be caused, for example, by a movement of the structure to be represented. In particular, the deviation that is brought about by the movement of the structure to be represented may be larger than a deviation that is brought about by the image noise of the individual image dataset and the image noise of the further individual image dataset. In particular, the deviation value in particular embodiments may also be understood as a movement value. For example, the deviation value may be high if a large deviation exists between the individual image dataset and the further individual image dataset, or may be low if a small deviation exists between the individual image dataset and the further individual image dataset. A large deviation may indicate, in particular, a movement.

An advantage of this embodiment is that an image content of the input image data may be categorized according to the predetermined checking rule dependent upon the deviation value. For example, the first or the second noise reduction algorithm may be applied to a region of the input image data dependent upon the deviation value. It may be particularly advantageous to generate the resultant image data dependent upon a deviation value if, for example, the first noise reduction algorithm achieves a better or significantly better result for moving structures than the second noise reduction algorithm or vice versa.

According to at least one further embodiment, for determining the respective deviation value, a difference dataset is determined from the individual image dataset and the further individual image dataset. Furthermore, for each image point of the plurality of image points, a variance is established dependent upon the difference dataset. Finally, the respective deviation value depends upon the respective variance.

The difference dataset may be determined in that for each image point of the plurality of image points, a difference or an amount of the difference is formed between the input image point value and of the further input image point value.

In order to determine the respective variance, from a subset of image points from the plurality of image points, a mean value may be formed from the respective subset. The subset of image points may be found in a surrounding area around the respective image point. The subset of image points may be referred to as a region of interest (ROI) or a window. On the basis of the mean value of the respective subset, the respective variance may be established for the respective image point. The respective variance may be referred to as a local variance.

Optionally, the respective variance may also be established on the basis of a recursive approach.

In particular, the determination of the respective variance may include a normalization to a reference value, for example, a predicted noise variance. The predicted noise variance may be determined, for example, by way of a noise level function estimate (NLFE). The predicted noise variance may be calculated, for example, dependent upon system parameters of the imaging system that has generated the input image data and/or by way of physical and/or statistical model formation. In particular, the respectively normalized variance may be a variable that is able to take a value greater than or equal to one.

If, in the case of the normalized variance the deviation value for an image point corresponds, for example, to a value of one, this may indicate that no movement took place at the site. In the case of the normalized variance, a change or a movement within the image point may be recognized, for example, by way of a deviation value that is significantly greater than one, that is to say, in particular, greater than one by at least a predetermined tolerance value. However, a continuous transition between “unmoving” and “moving” may be provided dependent upon the deviation value. A procedure of this type may be referred to as a movement detector.

An advantage of this embodiment is that with the deviation value, a particularly expressive measure may be given for the change of the input image point value relative to the respective further input image point value and, dependent thereon, a particularly advantageous further processing may be selected by applying the first and/or second noise reduction algorithm.

According to at least one further embodiment, the combination for each image point of the plurality of image points depends upon a weighted sum of the respective first noise-reduced image point value and of the respective further image point value, in particular, a weighted sum of the respective first noise-reduced image point value and the respective second noise-reduced image point value. Furthermore, at least one weighting factor of the weighted total depends upon the result of the checking.

In other words, in order to determine the combination for each image point of the plurality of image points, the weighted sum of the respective first noise-reduced image point value weighted with a first weighting factor and the respective further image point value weighted with a second weighting factor may be formed. A sum of the first weighting factor and of the second weighting factor may be, in particular, equal to one. Thereby, for example, a data integrity of the resultant image data may be provided. Other normalizations are also possible.

An advantage of this embodiment is that, dependent upon the checking for each image point of the plurality of image points, a resultant image point may be determined that corresponds either to the first noise-reduced image point value or to the second noise-reduced image point value or to a combination of these two image point values. Therefore, an attribution of an optimum noise reduction algorithm may be undertaken and a transition may be calculated.

According to at least one further embodiment, the at least one weighting factor of the weighted sum depends upon the deviation value, in particular, the variance.

In other words, for example, the first weighting factor may be equal to one and the second weighting factor may be equal to zero for a very high deviation value. Thus, the resultant image point value corresponding to this image point may represent the first noise-reduced image point value. Similarly, the second weighting factor may be equal to one and the first weighting factor may be equal to zero for a very small deviation value, so that the corresponding resultant image point value for this image point corresponds, for example, to the further image point. For example, in a central region of the deviation value, a transition may be provided at which a portion of the first noise-reduced image point value and a portion of the further image point value are incorporated into the resultant image point value. A sum of the first weighting factor and of the second weighting factor may be equal to one, in particular, for an identical deviation value.

A specification of the first weighting factor and/or of the second weighting factor or their dependency upon the deviation value may be established, for example, by way of empirical methods. For example, for this purpose, image data may be generated repeatedly by reproducible processes and results may be compared with one another by applying the first noise reduction algorithm or the second noise reduction algorithm. In particular, for this purpose, the signal-to-noise ratio of the results may be compared with one another. The reproducible processes may then contain, for example, firstly a movement and secondly a standstill of a structure. Thus, for the respective process, which is to say, the respective deviation value, the advantageous noise reduction algorithm may be provided with a high weighting factor and the less favorable noise reduction algorithm may be provided with a low weighting factor and vice versa.

For example, a noise reduction that is adaptive to a movement may thus be implemented for each image point of the plurality of image points on the basis of the input image data.

An advantage of this embodiment is that, dependent upon the deviation value for each image point of the plurality of image points, a favorable noise reduction algorithm may be selected adaptively and/or a favorable combination of the first and the second noise reduction algorithm.

For example, a linear transition between the first noise-reduced image point value and the further image point value may be provided. The following then applies, in particular:

$${g}_{1} = \{ \begin{matrix}0 , if 1 \leq A < {A}_{1} , \\ ( A - {A}_{1} ) / ( {A}_{2} - {A}_{1} ) , if {A}_{1} < A \leq {A}_{2} \\ 1 , if A > {A}_{2}\end{matrix} \\ {g}_{2} = \{ \begin{matrix}1 , if 1 \leq A < {A}_{1} , \\ ( {A}_{2} - A ) / ( {A}_{2} - {A}_{1} ) , if {A}_{1} < A \leq {A}_{2} \\ 1 , if A > {A}_{2}\end{matrix}$$

Therein, g₁ denotes the first weighting factor, g₂ is the second weighting factor, A is the deviation value, A₁ is a first specified boundary value, and A₂ is a second specified boundary value. Alternatively, other transitions, (e.g., non-linear transitions), are also possible.

According to at least one further embodiment, the imaging system is a medical imaging system.

In particular, the medical imaging system may correspond to an X-ray based imaging system, a positron-emission tomography (PET) system, a magnetic resonance tomography (MRT) system, a computed tomography (CT) system, a C-arm imaging system, or a classic X-ray device.

The input image data may be patient image data of a body of a patient or a portion of a body of a patient. In particular, the image content of the input image data may include a representation of an organ or another body part of the patient.

According to a further aspect, an imaging method is provided. By an imaging system, input image data is generated and resultant image data is generated according to a computer-implemented method for noise reduction on the basis of the input image data.

According to a further aspect, a data processing system is provided that is configured to carry out a computer-implemented method disclosed herein.

The expressions “data processing system” and “at least one data processing device” may be used interchangeably in the present disclosure. A data processing device may be understood, in particular, to be a data processing device that includes a processing circuit. The data processing device may process data for carrying out computation operations. This also may cover operations to perform indexed access operations to a data structure, for example, a look-up table (LUT) and also a hardware-implemented data processing procedure.

The data processing device may include one or more computers, one or more microcontrollers and/or one or more integrated circuits, for example, one or more application-specific integrated circuits (ASICs), one or more field-programmable gate arrays (FPGA), and/or one or more system on a chip (SoC) units. The data processing device may also include one or more processors, for example, one or more microprocessors, one or more central processing units (CPUs), one or more graphics processing units (GPUs), and/or one or more signal processors, in particular, one or more digital signal processors (DSPs). The data processing device may also include a physical or a virtual network of computers or others of the aforementioned units.

In different embodiments, the data processing device includes one or more hardware and/or software interfaces and/or one or more storage units.

A storage unit may be configured as a volatile data store, for example, as a dynamic random access memory (DRAM) or as a static random access memory (SRAM) or as a non-volatile data store, for example, a read-only memory (ROM) as a programmable read-only memory (PROM) as an erasable programmable read-only memory (EPROM) as an electrically erasable programmable read-only memory (EEPROM) as a flash memory or flash-EEPROM, as a ferroelectric random access memory (FRAM) as a magnetoresistive random access memory (MRAM) or as a phase-change random access memory (PCRAM).

According to a further aspect, an imaging apparatus is provided, having a data processing system and an imaging system configured to generate the input image data.

Further embodiments of the imaging apparatus follow directly from the different embodiments of the computer-implemented method and vice versa. In particular, individual features and corresponding explanations and advantages relating to the different embodiments of the computer-implemented method may be transferred analogously to corresponding embodiments of the imaging apparatus. In particular, the imaging apparatus is configured and programmed for carrying out a computer-implemented method and/or an imaging method. In particular, the imaging apparatus carries out the computer-implemented method and/or the imaging method.

According to a further aspect, a first computer program product is provided, having first commands that, on execution by a data processing system, cause the data processing system to carry out a method.

According to a further aspect, a second computer program product is provided, having second commands that, on execution by an imaging apparatus, cause the imaging apparatus to carry out an imaging method.

According to a further aspect, a (e.g., non-transitory) computer-readable storage medium is provided that stores a first computer program product and/or a second computer program product.

The first computer program product, the second computer program product, and the computer-readable storage medium are each computer program products with the first commands and/or the second commands.

The first and/or second commands may be present, for example, as program code. The program code may be provided, for example, as binary code or assembler and/or as source code of a programming language, for example, C and/or as a program script, for example, Python.

Further features and feature combinations are disclosed in the drawings and their description as well as in the claims. In particular, further embodiments do not necessarily include all the features of one of the claims. Further embodiments of the disclosure may have features or combinations of features that are not given in the claims.

The disclosure is now described in greater detail by reference to specific exemplary embodiments and the associated schematic drawings. In the figures, the same or functionally identical elements may have been provided with the same reference signs. The description of the same or functionally identical elements is, where relevant, not necessarily be repeated in relation to different drawings.

### BRIEF DESCRIPTION OF THE DRAWINGS

FIG. 1 shows schematically an embodiment of an imaging apparatus.

FIG. 2 shows a schematic block diagram of an embodiment of a computer-implemented method for noise reduction.

FIG. 3 shows a schematic block diagram of a further embodiment of a computer-implemented method for noise reduction.

FIG. 4 shows a schematic block diagram of a further embodiment of a computer-implemented method for noise reduction.

FIG. 5 shows a schematic block diagram of a further embodiment of a computer-implemented method for noise reduction.

FIG. 6 shows a schematic representation of an example of an artificial neural network.

FIG. 7 shows a schematic representation of an example of a convolutional neural network.

FIG. 8 shows a schematic representation of an example of a further convolutional neural network.

### DETAILED DESCRIPTION

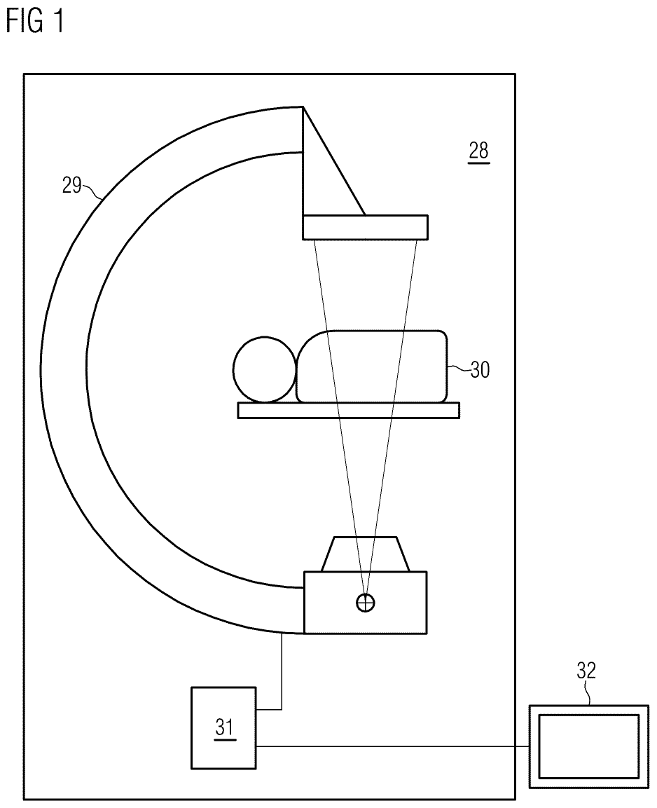

FIG. 1 shows a schematic representation of an exemplary embodiment of an imaging apparatus 28. The imaging apparatus 28 has a data processing system 31 and an imaging system 29. The data processing system 31 may be configured to represent the input image data 1 or other image data on a display unit 32. In some embodiments, the display unit 32 may also be part of the imaging apparatus 28. The data processing system 31 is configured, for example, to carry out a computer-implemented method for noise reduction in the input image data 1. The display unit 32 is configured, for example, to display the input image data 1 and/or resultant image data 11.

By way of example, the imaging system 29 is shown as a C-arm X-ray device with an X-ray source and an X-ray detector. The imaging system 29 may thus be configured, for example, as a CBCT device. However, the following explanations may be transferred similarly to other imaging systems 29.

The object 30 may be a patient or a body part of the patient. The patient may be placed on a patient support of the imaging apparatus 28.

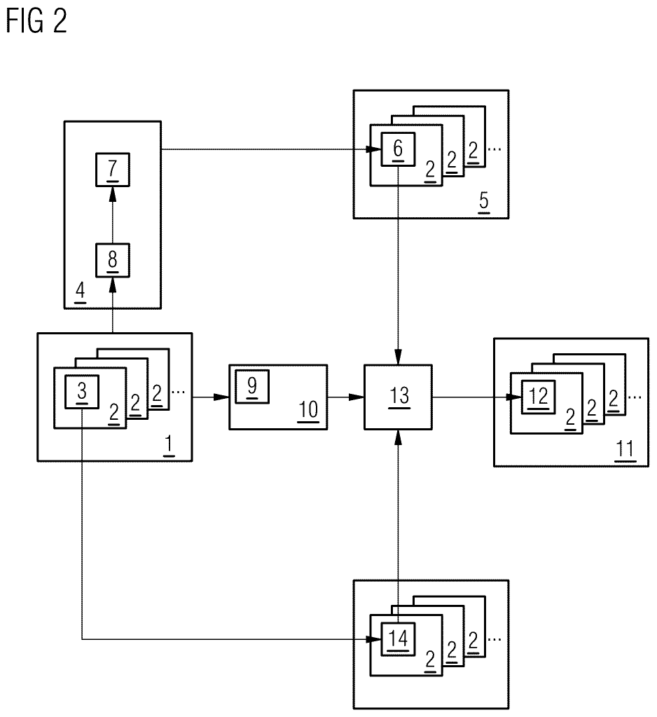

FIG. 2 shows a schematic block diagram of an exemplary embodiment of a computer-implemented method for noise reduction in input image data 1 generated by an imaging system 29. Therein, the input image data 1 has, for example, an input image point value 3 for each image point of a plurality of image points 2. On the basis of the input image data 1, by using a first noise reduction algorithm 4, first noise-reduced image data 5 is generated that has a first noise-reduced image point value 6 for each image point of the plurality of image points 2. The application of the first noise reduction algorithm 4 involves an application of a trained machine learning model MLM 7 to input data 8 dependent upon the input image data 1. An image content 9 of the input image data 1 is checked according to a predetermined checking rule 10. In addition, resultant image data 11 is generated on the basis of the input image data 1, wherein the resultant image data 11 for each image point of the plurality of image points 2 has a resultant image point value 12. Therein, each resultant image point value 12 is given by a combination 13, dependent upon a result of the checking, of each first noise-reduced image point value 6 and a respective further image point value 14 that is dependent upon the input image data 1, for example, upon the respective input image point value 3.

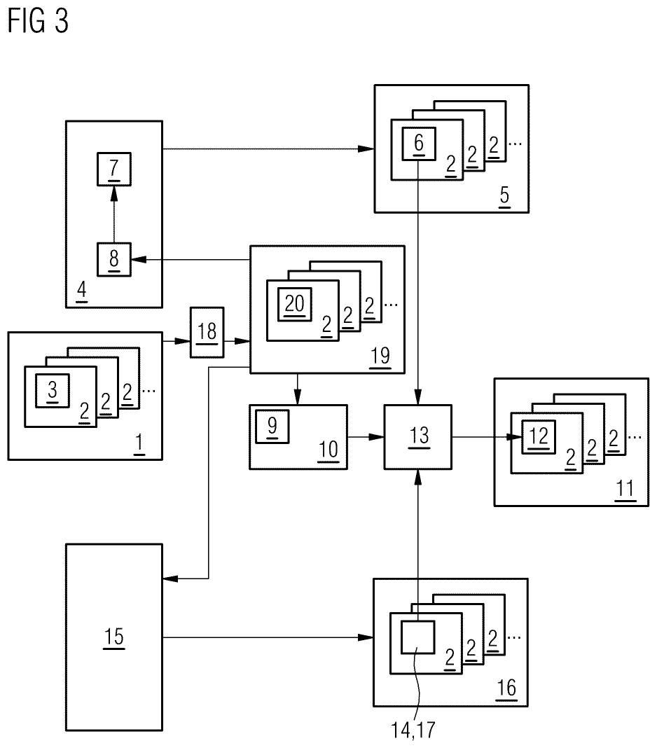

FIG. 3 shows a schematic block diagram of a further exemplary embodiment of a computer-implemented method for noise reduction that is based upon the embodiment of FIG. 2. Therein, for example, on the basis of the input image data 1, applying a second noise reduction algorithm 15, second noise-reduced image data 16 is generated. The second noise-reduced image data 16 have a second noise-reduced image point value 17 for each image point of the plurality of image points 2. In addition, each further image point value 14 is provided by the respective second noise-reduced image point value 17.

The second noise reduction algorithm 15 may therein be applied, for example, without applying the trained machine learning model 7 or a further trained machine learning model.

FIG. 3 also shows an optional application of a variance-stabilizing transformation 18 to the input image data 1. Through the application of the variance-stabilizing transformation 18, for example, variance-stabilized input image data 19 may be generated on the basis of the input image data 1. The variance-stabilized input image data 19 may have, for each image point of the plurality of image points 2, a variance-stabilized image point value 20. In particular, the input data 8 may be dependent upon the variance-stabilized input image data 19. Also, the checking of the image content 9 may be dependent upon the variance-stabilized input image data 19. The application of the second noise reduction algorithm 15 may be dependent upon the variance-stabilized input image data 19.

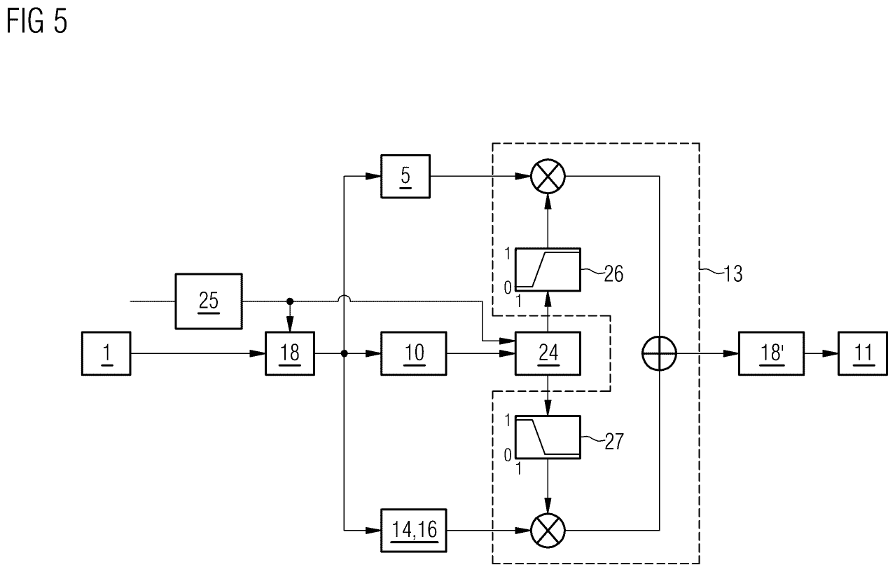

Similarly, the generation of the resultant image data 11 may contain an application of an inverse variance-stabilizing transformation 18′ (see also FIG. 5) to the combination 13. Otherwise, the descriptions relating to FIG. 2 may apply fully or partially to the embodiment shown in FIG. 3.

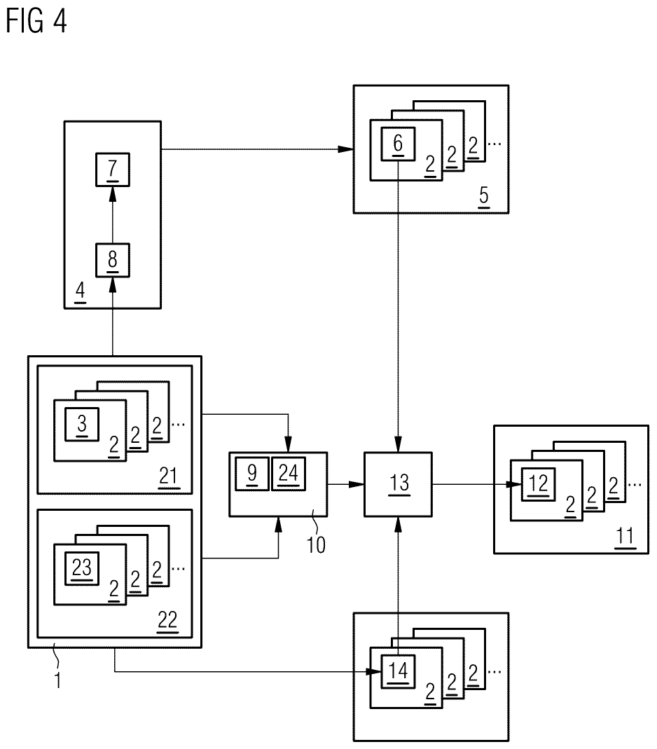

FIG. 4 shows a schematic block diagram of a further exemplary embodiment of a computer-implemented method for noise reduction. Therein, the input image data 1 includes an individual image dataset 21 that has, in particular, for each image point of the plurality of image points 2, the input image point value 3. In addition, the input image data 1 includes a further individual image dataset 22 that has, in particular, for each image point of the plurality of image points 2, a further input image point value 23. In particular, the individual image dataset 21 and the further individual image dataset 22 follow one another temporally. Furthermore, the image content 9 is checked dependent upon the individual image dataset 21 and the further individual image dataset 22 in accordance with the predetermined checking rule 10.

In particular, in accordance with the predetermined checking rule 10, dependent upon the individual image dataset 21 and the further individual image dataset 22 for each image point of the plurality of image points 2, a deviation value 24 may be formed for a deviation of the individual image dataset 21 from the further individual image dataset 22. The combination 13 may be dependent upon the respective deviation value 24. In particular, the input image data 1 may thus contain an image series in which the individual image dataset 21 and the further individual image dataset 22 have been recorded temporally sequentially, in particular, directly sequentially. In particular, the resultant image data 11 contains only one image dataset. In other words, the resultant image data 11 may have just one image.

Otherwise, the descriptions relating to FIG. 2 and FIG. 3 may apply fully or partially to the embodiment shown in FIG. 4.

FIG. 5 shows a schematic block diagram of a further exemplary embodiment of a computer-implemented method for noise reduction. The representation involves an exemplary determination of a reference value 25 that may be given, for example, as a comparison measure for the deviation value 24 in the form of a predicted noise variance. Furthermore, the combination 13 may contain a weighted sum. The weighted sum may contain, for example, for each image point of the plurality of image points 2, a first weighting function, which, dependent upon the respective deviation value 24, applies a corresponding first weighting factor 26 to the corresponding first noise-reduced image point value 6. Similarly, the weighted sum may contain a second weighting function, which, dependent upon the respective deviation value 24, applies a corresponding second weighting factor 27 to the corresponding further image point value 14. The second weighting function may therein follow directly from the first weighting function so that, in particular, the sum of the first weighting factor 26 and the second weighting factor 27 is equal to one. Each resultant image point value 12 may be generated by a sum formation from the two image point values each weighted with the respective weighting factor 26, 27.

In addition, FIG. 5 shows a representation of an inverse variance-stabilizing transformation 18′ for generating the resultant image data 11. Otherwise, the descriptions relating to FIG. 2, FIG. 3, and FIG. 4 may apply fully or in part to the embodiment shown in FIG. 5.

In particular, different embodiments of the disclosure may be particularly advantageous for a representation of static background structures and moving structures (for example, a static spinal column beside a moving heart, leg or anesthetized skull). Therefore, in the image contents 9, in particular, static background structures and moving structures are distinguished. In the case of moving structures, for example, the first noise reduction algorithm 4 is then applied in some areas and, in the case of static background structures, for example, the second noise reduction algorithm 15 is applied. From the combination 13 of the first noise reduction algorithm 4, for example, an AI denoiser with the second noise reduction algorithm 15, for example, a classic image processing method for denoising, a hybrid method is produced. Accordingly, switching takes place locally or in an area-adaptive manner between two variants or the variants are weighted dependent upon the assignment to the static background structure or the moving structure. For each image content 9, the respective best denoiser is used. In the case of moving structures, this may be the AI denoiser since this functions only on an individual image dataset 21 (intraframe). In the case of static background structures, for example, a temporal denoiser that averages over two or more individual image datasets 21, 22 may be more suitable. The second noise reduction algorithm 15 may be an arithmetic averaging filter or a recursive, weighted filter (k-factor).

The first weighting factor 26 and the second weighting factor 27 have, for example, a value region [0,1] and behave inversely. A partitioning of the input image data 1 into moving and static regions may thus take place.

For example, a difference dataset may be determined in that for each image point of the plurality of image points 2, a difference or an amount of the difference between the input image point value 3 and the further input image point value 23 is formed. In the difference dataset, for example, for each image point, a subset of image points of the plurality of image points 2 may be specified in a region around the image point. The subset of image points may also be referred to as a region of interest (ROI) or a window. For the image point values of the subset of image points, a variance of the subset may be calculated. The variance of the subset may also be designated a local variance and may be associated with the respective image point. Alternatively, or additionally, the local variance may be established with a recursion formula from a plurality of neighboring local variances. The deviation value 24 may correspond to the local variance or may be identical thereto.

In particular, the local variance may be normalized by way of a predicted noise variance in order to enable an objective evaluation of the local variance. The predicted noise variance may be calculated from system parameters of the imaging system 29 that has generated the input image data 1 and/or by way of physical and/or statistical model formation. The predicted noise variance may also be designated the noise level function estimate (NLFE). The normalized local variance may take a value that is greater than or equal to one. The value one may mean that a static structure is represented at the respective image point. The further from one that the value may be removed, the more a moving structure may be represented at the respective image point.

A first weighting factor 26 may be established dependent upon the normalized local variance. For example, in the case of a normalized variance with a value of one, the first weighting factor 26 may take a value of zero and, given a normalized local variance with a large value, the first weighting factor 26 may take a value of one.

The second weighting factor 27 may also be established dependent upon the normalized local variance. For example, in the case of a normalized local variance with a value of one, the second weighting factor 27 may take a value of one and, given a normalized local variance with a large value, the second weighting factor 27 may take a value of zero.

For each image point of the plurality of image points 2, by the normalized local variance, the resultant image point value 12 may be established from a sum of the first noise-reduced image point value 6 multiplied by the first weighting factor 26 and the second noise-reduced image point value 17 multiplied by the second weighting factor 27.

The determination of the deviation value 24 may also take place, for example, involving the checking rule 10 and the determination of the reference value 25, on the basis of a frequency analysis.

The trained MLM 7 applied for the application of the first noise reduction algorithm 4 may contain, for example, an artificial neural network, ANN 800.

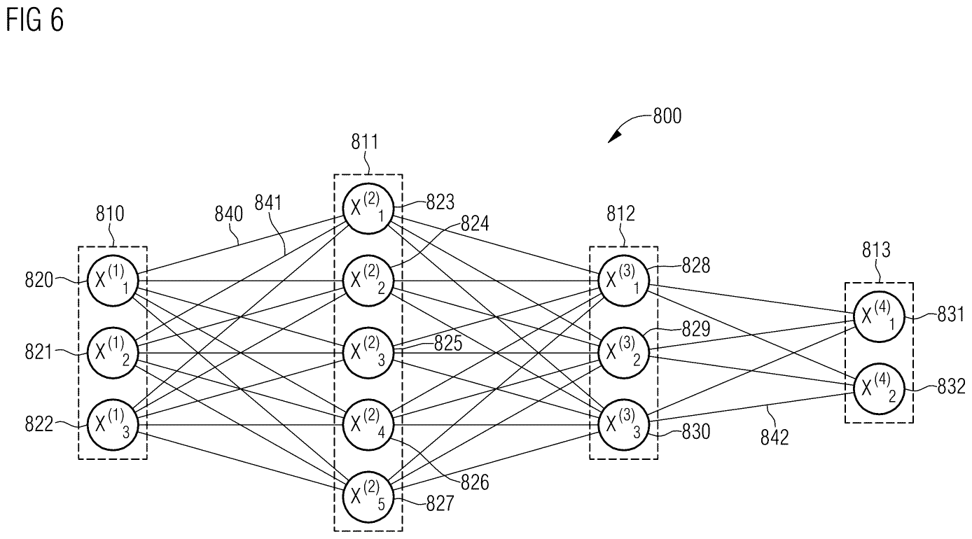

FIG. 6 shows an exemplary embodiment of an ANN 800. The ANN 800 includes nodes 820, . . . , 832 and edges 840, . . . , 842, wherein each edge 840, . . . , 842 is a directed connection from a first node 820, . . . , 832 to a second node 820, . . . , 832. In certain examples, the first node 820, . . . , 832 and the second node 820, . . . , 832 are different nodes 820, . . . , 832. However, it is also possible that the first node 820, . . . , 832 and the second node 820, . . . , 832 are identical. In FIG. 6, by way of example, the edge 840 is a directed connection from the node 820 to the node 823 and the edge 842 is a directed connection from the node 830 to the node 832. An edge 840, . . . , 842 from a first node 820, . . . , 832 to a second node 820, . . . , 832 may also be designated an incoming edge for the second node 820, . . . , 832 and as an outgoing edge for the first node 820, . . . , 832.

In this example, the nodes 820, . . . , 832 of the ANN 800 may be arranged in layers 810, . . . , 813, wherein the layers may have an intrinsic order that is introduced by the edges 840, . . . , 842 between the nodes 820, . . . , 832. In particular, edges 840, . . . , 842 may only exist between adjacent layers of nodes. In the example shown, there is an input layer 810 that includes only the nodes 820, . . . , 822 without incoming edges, an output layer 813 that includes only the nodes 831, 832 without outgoing edges and hidden layers 811, 812 between the input layer 810 and the output layer 813. In certain examples, the number of hidden layers 811, 812 may be selected as desired. In a multilayer perceptron, MLP, this number is at least one. The number of nodes 820, . . . , 822 within the input layer 810 may relate to the number of input values of the artificial neural network 800 and the number of nodes 831, 832 within the output layer 813 may relate to the number of output values of the artificial neural network 800.

In particular, a real number may be assigned as the value to each node 820, . . . , 832 of the artificial neural network 800. Therein, x⁽ⁿ⁾ᵢ denotes the value of the i-th node 820, . . . , 832 of the n-th layer 810, . . . , 813. The values of the nodes 820, . . . , 822 of the input layer 810 correspond to the input values of the artificial neural network 800. The values of the nodes 831, 832 of the input layer 813 correspond to the output value of the artificial neural network 800. In addition, each edge 840, . . . , 842 may have a weight that is a real number. In particular, the weight is a real number within the interval [−1, 1] or within the interval [0, 1]. Therein, w^{(m,n)}_{i,j} denotes the weight of the edge between the i-th node 820, . . . 832 of the m-th layer 810, . . . , 813 and the j-th node 820, . . . , 832 of the n-th layer 810, 813. Furthermore, the abbreviation w^{(m,n)}_{i,j} is defined for the weight w^{(n,n+1)}_{i,j}. In order to calculate the output values of the neural network 800, in particular, the input values are propagated by way of the neural network 800. In particular, the values of the nodes 820, . . . , 832 of the (n+1)-th layer 810, . . . , 813 may be calculated on the basis of the values of the nodes 820, . . . , 832 of the n-th layer 810, . . . , 813 with:

$${x}_{j}^{( n + 1 )} = f ( {\sum }_{i} {x}_{i}^{( n )} {w}_{i , j}^{( n )} )$$

Therein, the function f is referred to as the transfer function or activation function. Known transfer functions are step functions, sigmoid functions (for example, the logistic function, the generalized logistic function, the hyperbolic tangent, the arctangent, the error function, the smoothstep function) or rectifier functions. The transfer function is used, for example, for normalization. In particular, the values are propagated layer by layer through the neural network 800, wherein the values of the input layer 810 are given by the input of the neural network 800, wherein the values of the first hidden layer 811 may be calculated on the basis of the values of the input layer 810 of the neural network 800, wherein the values of the second hidden layer 812 may be calculated on the basis of the values of the first hidden layer 811, and so on.

In order to specify the values w^{(m,n)}_{i,j} for the edges, the neural network 800 is trained with training data. The training data includes, in particular, training input data and training output data (referred to as tᵢ). In a training act, the neural network 800 is applied to the training input data in order to generate calculated output data. In particular, the training data and the calculated output data include a number of values that correspond to the number of nodes of the output layer. In particular, a comparison between the calculated output data and the training data is used to adjust the weights recursively within the neural network 800 (a back-propagation algorithm). In particular, the weights are adjusted according to the following formula:

$${w}_{i , j}^{′ ( n )} = {w}_{i , j}^{( n )} - γ {δ}_{j}^{( n )} {x}_{i}^{( n )} ,$$

wherein γ is a predefined learning rate and the numbers δ(n)ⱼ may be calculated recursively according to:

$${δ}_{j}^{( n )} = ( {\sum }_{k} {δ}_{k}^{( n + 1 )} {w}_{j , k}^{( n + 1 )} ) {f}^{′} ( {x}_{i}^{( n )} {w}_{i , j}^{( n )} )$$

on the basis of δ⁽ⁿ⁺¹⁾; if the (n+1)-th layer is not the output layer 813, and:

$${δ}_{j}^{( n )} = ( {x}_{j}^{( n + 1 )} - {t}_{j}^{( n + 1 )} ) {f}^{′} ( {x}_{i}^{( n )} {w}_{i , j}^{( n )} ) ,$$

if the (n+1)-th layer is the output layer 813, wherein f′ is the first derivative of the activation function and t⁽ⁿ⁺¹⁾; is the comparative training value for the j-th nodes of the output layer 813.

In some embodiments, the ANN may be configured as a convolutional neural network CNN. A CNN is an ANN that uses a convolution operation in at least one of its layers in place of a general matrix multiplication. These layers are referred to as convolutional layers. In particular, a convolutional layer computes a scalar product of one or more convolutional kernels with the input data of the convolutional layer, wherein the entries of the one or the plurality of convolutional kernels are the parameters or weights that may be adjusted through training. In particular, the inner Frobenius product and the ReLu activation function may be used. A convolutional neural network may include additional layers, for example, pooling layers, fully connected layers, and/or normalization layers.

Through the use of convolutional neural networks, the input may be processed very efficiently since a convolution operation that is based upon different kernels may extract different image features so that by way of the adjustment of the weights of the convolutional kernel, the relevant image features may be determined during the training. Furthermore, on the basis of the shared use of the weights in the convolutional kernels, fewer parameters are trained, which prevents overfitting in the training phase and enables a more rapid training or more layers in the network, so that the output of the network is improved.

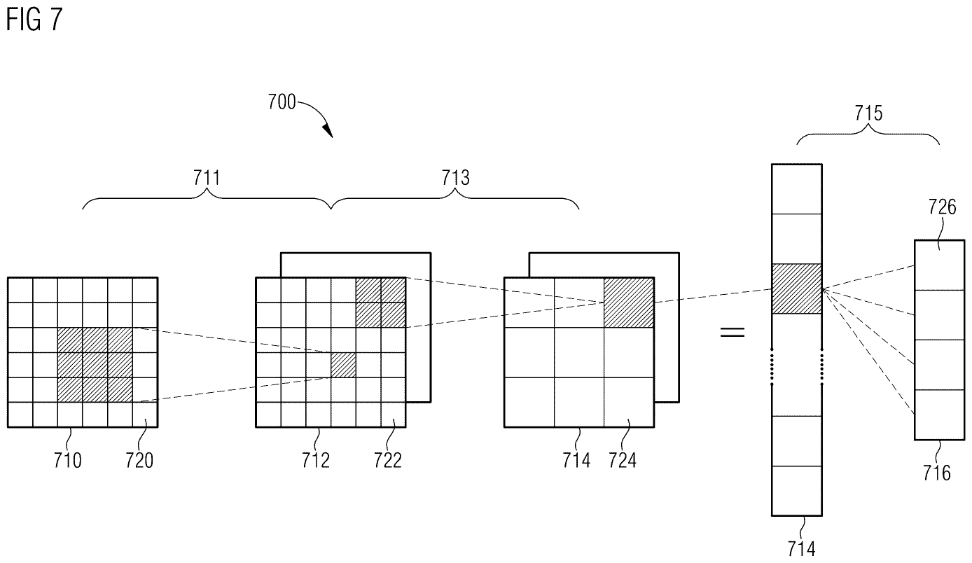

FIG. 7 shows an exemplary embodiment of a convolutional neural network 700. In the embodiment shown, the convolutional neural network 700 includes an input node layer 710, a convolutional layer 711, a pooling layer 713, a fully connected layer 714 and an output node layer 716 as well as hidden node layers 712, 714. Alternatively, the convolutional neural network 700 may also include a plurality of convolutional layers 711, a plurality of pooling layers 713 and/or a plurality of fully connected layers 715 as well as other types of layers. The sequence of the layers may be selected as desired, and fully connected layers 715 may be used as the last layers before the output layer 716.

In particular, in a convolutional neural network 700, the nodes 720, 722, 724 of a node layer 710, 712, 714 may be regarded as a d-dimensional matrix or as a d-dimensional image. In particular, in the two-dimensional case, the value of the node 720, 722, 724 indexed with i and j may be identified in the n-th node layer 710, 712, 714 as x(n)[i,j]. However, the arrangement of the nodes 720, 722, 724 of a node layer 710, 712, 714 has, as such, no influence on the calculations that are carried out within the convolutional neural network 700, since these are given solely by the structure and the weight of the edges.

A convolutional layer 711 is a connecting layer between a preceding node layer 710 with node values x(n−1) and a succeeding node layer 712 with node values x(n). A convolutional layer 711 is characterized, in particular, by the structure and the weights of the incoming edges that form a convolution operation on the basis of a particular number of kernels. In particular, the structure and the weights of the edges of the convolutional layer 711 are selected such that the values x(n) of the nodes 722 of the succeeding node layer 712 are defined as a convolution x(n)=K*x(n−1) on the basis of the values x(n−1) of the nodes 720 of the preceding node layer 710, wherein the convolution * in the two-dimensional case is defined as:

$${x}^{( n )} [ i , j ] = ( K * {x}^{( n - 1 )} ) [ i , j ] = {\sum }_{{i}^{′}} {\sum }_{j ′} K [ {i}^{′} , {j}^{′} ] \cdot {x}^{( n - 1 )} [ i - {i}^{′} , j - {j}^{′} ] .$$

The kernel K is a d-dimensional matrix, in the present example a two-dimensional matrix that may be small as compared with the number of nodes 720, 722, for example, a 3×3 matrix or a 5×5 matrix. This means, in particular, that the weights of the edges in the convolutional layer 711 are not independent, but rather are selected such that they generate the above convolution equation. In particular, for a kernel that is a 3×3 matrix, only 9 dependent weights, wherein each entry of the kernel matrix corresponds to an independent weight, regardless of the number of nodes 720, 722 in the preceding node layer 710 and the succeeding node layer 712.

In certain examples, convolutional neural networks 700 use node layers 710, 712, 714 with a plurality of channels, in particular, due to the use of a plurality of kernels in the convolutional layers 711. In these cases, the node layers may be understood as (d+1)-dimensional matrices, wherein the first dimension indexes the channels. The effect of a convolutional layer 711 is then defined in a two-dimensional example as:

$${x}_{b}^{( n )} [ i , j ] = {\sum }_{a} ( {K}_{a , b} * {x}_{a}^{( n - 1 )} [ i , j ] = {\sum }_{a} {\sum }_{{i}^{′}} {\sum }_{{j}^{′}} {K}_{a , b} [ {i}^{′} , {j}^{′} ] \cdot {x}_{a}^{( n - 1 )} [ i - {i}^{′} , j - {j}^{′} ] ,$$

where

$${x}_{a}^{( n )}$$

represents the a-th channel of the preceding node layer 710,

$${x}_{b}^{( n )}$$

represents the b-th channnel of the succeeding node layer 712, and K_{a,b} represents one of the kernels. If a convolutional layer 711 acts upon a preceding node layer 710 with A-channels and a succeeding node layer 712 with B-channels, there are A-B independent d-dimensional kernels K_{a,b}.

In certain examples, in convolutional neural networks 700, activation functions are used. In this exemplary embodiment, ReLUs (rectified linear units) are used, wherein R(z)=max(0, z) so that the effect of the convolutional layer 711 in the two-dimensional example is:

$${x}_{b}^{( n )} [ i , j ] = R ( {\sum }_{a} ( {K}_{a , b} * {x}_{a}^{( n - 1 )} [ i , j ] ) = R ( {\sum }_{a} {\sum }_{{i}^{′}} \cdot {\sum }_{{j}^{′}} {K}_{a , b} [ {i}^{′} , {j}^{′} ] \cdot {x}_{a}^{( n - 1 )} [ i - {i}^{′} , j - {j}^{′} ] ) .$$

It is also possible to use other activation functions, for example, ELU (exponential linear unit), LeakyReLU, sigmoid functions, tanh or softmax.

In the embodiment shown, the input layer 710 contains 36 nodes 720 that are arranged in a two-dimensional 6×6 matrix. The first hidden node layer 712 contains 72 nodes 722 arranged as two-dimensional 6×6 matrices, wherein each matrix of the two matrices is the result of a convolution of the values of the input layer with a 3×3 kernel within the convolutional layer 711. Equivalent thereto, the nodes 722 of the first hidden node layer 712 may be interpreted as a three-dimensional 2×6×6 matrix, wherein the first dimension corresponds to the channel dimension.

An advantage of the use of convolutional layers 711 is that the spatially local correlation of the input data may be utilized in that a local connectivity pattern is created between the nodes of adjacent layers, in particular, in that each node is connected only to a small region of the nodes of the preceding layer.

A pooling layer 713 is a connecting layer between a preceding node layer 712 with node values x(n−1) and a succeeding node layer 714 with node values x(n). A pooling layer 713 may be characterized, in particular, by the structure and the weights of the edges and the activation function, which form a pooling operation on the basis of a non-linear pooling function f. For example, in the two-dimensional case, the values x(n) of the nodes 724 of the succeeding node layer 714 may be calculated, on the basis of the values x(n−1) of the nodes 722 of the anterior node layer 712 as follows:

$${x}_{b}^{( n )} [ i , j ] = f ( {x}_{b}^{( n - 1 )} [ {id}_{1} , {jd}_{2} ] , … , {x}_{b}^{( n - 1 )} [ ( i + 1 ) {d}_{1} - 1 , ( j + 1 ) {d}_{2} - 1 ] ) .$$

In other words, by way of the use of a pooling layer 713, the number of nodes 722, 724 may be reduced in that a number d1-d2 of adjacent nodes 722 in the preceding layer 712 are replaced by a single node 722 in the succeeding node layer 714 that is calculated as a function of the values of the number of adjacent nodes. The pooling function f may be, in particular, the max function, the mean value or the L2-norm. In particular, in a pooling layer 713, the weights of the incoming edges are fixed and are not changed by way of the training.

The advantage of the use of a pooling layer 713 is that the number of nodes 722, 724 and the number of parameters is reduced. This leads to a reduction of the calculation effort in the network and to a monitoring of the overfitting.

In the embodiment shown, the pooling layer 713 is a max pooling layer in which four adjacent nodes are replaced with just one single node, the value of which is formed by the maximum of the values of the four adjacent nodes. The max pooling is applied to each d-dimensional matrix of the preceding layer. In this embodiment, the max pooling is applied to each of the two-dimensional matrices, by which means the number of the nodes is reduced from 72 to 18.

In certain examples, the last layers of a convolutional neural network 700 may be fully connected layers 715. A fully connected layer 715 is a connecting layer between a preceding node layer 714 and a succeeding node layer 716. A fully connected layer 713 may be characterized in that a majority, in particular, all of the edges between the nodes 714 of the preceding node layer 714 and the nodes 716 of the succeeding node layer are present, and wherein the weight of each of these edges may be individually adjusted.

In this embodiment, the nodes 724 of the preceding node layer 714 and of the fully connected layer 715 are shown both as two-dimensional matrices and also as disconnected nodes that are shown as one row of nodes, wherein the number of the nodes has been reduced for greater clarity. This process is referred to as “flattening.” In this embodiment, the number of nodes 726 in the succeeding node layer 716 of the fully connected layer 715 is smaller than the number of nodes 724 in the preceding node layer 714. Alternatively, the number of nodes 726 may be the same or greater.

Furthermore, in this embodiment, the softmax activation function is used within the fully connected layer 715. By applying the softmax function, the sum of the values of all the nodes 726 of the output layer 716 is equal to 1 and all the values of all the nodes 726 of the output layer 716 are real numbers between 0 and 1. In particular, when the convolutional neural network 700 is used for categorizing input data, the values of the output layer 716 may be interpreted as the probability that the input data fall into one of the different categories.

In particular, convolutional neural networks 700 may be trained on the basis of the backpropagation algorithm. In order to prevent an overfitting, methods of regularization, for example, omitting nodes 720, . . . , 724, stochastic pooling, synthetic data usage, weight decay based upon L1 or L2 norms, and max-norm constraints.

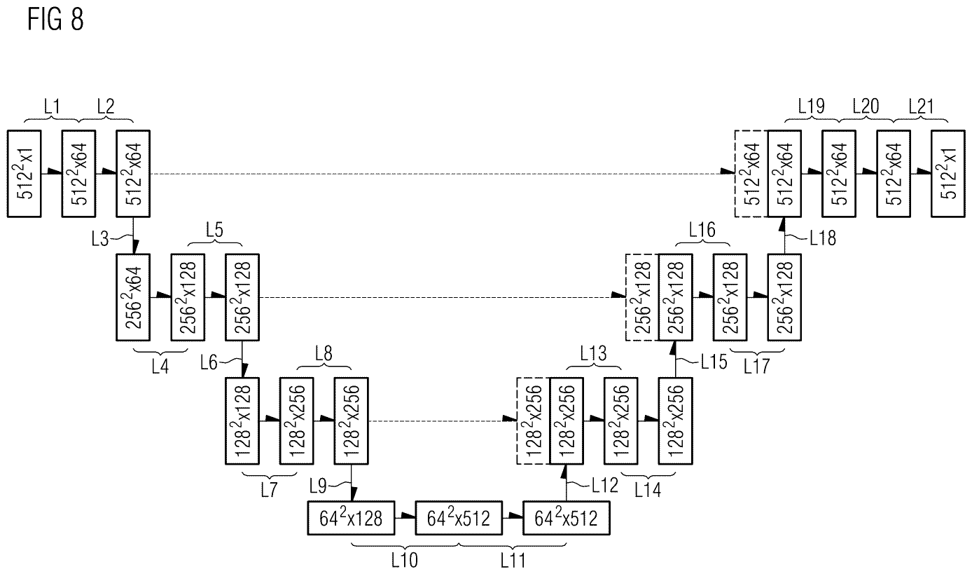

In the example of FIG. 8, the MLM 7 is a CNN 700 with a U-Net structure. In the example shown, the input data for the CNN 700 is a two-dimensional medical image with 512×512 pixels, wherein each pixel contains an intensity value. The CNN 700 contains convolutional layers that are shown with solid horizontal arrows, pooling layers that are shown with solid downward-pointing arrows and upsampling layers that are shown with solid upward-pointing arrows. The number of nodes is shown in the boxes in each case. Within the U-Net structure, firstly, the input images are downsampled, in particular by shrinking the images and increasing the number of channels. Subsequently, they are upsampled, in particular, by enlarging the images and reducing the number of channels in order to generate a transformed image.

All except the last convolutional layers L1, L2, L4, L5, L7, L8, L10, L11, L13, L14, L16, L17, L19, L20 use 3×3 kernels with a padding of 1, the ReLU activation function and a number of filters or convolutional kernels that corresponds to the number of channels in the respective node layers, as shown in FIG. 6. The last convolutional layer uses a 1×1 kernel without padding and the ReLU activation function.

The pooling layers L3, L6, L9 are max pooling layers that replace four adjacent nodes with just one node, the value being the maximum of the values of the four adjacent nodes. The upsampling layers L12, L15, L18 are transposed convolutional layers with 3×3 kernels and stride 2, which effectively quadruples the number of nodes. The dashed horizontal arrows correspond to concatenation operations in which the output of a convolutional layer L2, L5, L8 of the downsampling branch of the U-Net structure is used as additional inputs for a convolutional layer L13, L16, L19 of the upsampling branch of the U-Net structure. This additional input data is treated as additional channels in the input node layer for the convolutional layer L13, L16, L19 of the upsampling branch.

For the training of the CNN, a database with 500 first medical images was used, wherein each segmentation mask was generated on the basis of annotations from radiological experts. In particular, the experts determined, for each of the 500 first medical images, a segmentation mask for a structure of interest, wherein a value of 1 was assigned to the pixels corresponding to the structure of interest and a value of 0 was assigned to the pixels not corresponding to the structure of interest. The database was subdivided into training data (320 data sets), validation data (80 data sets) and test data (100 data sets). For training the CNN, the backpropagation algorithm was used, based upon a binary cross-entropy loss function:

$$L ( x , y ) = {\sum }_{i} {\sum }_{j} BCE ( y [ i , j ] )$$

$$\text{where:}$$

$$BCE ( a , b ) := - a log ( b ) ( b ) - ( 1 - a ) log ( 1 - b ) ,$$

where x denotes a first medical image, y determines the corresponding segmentation mask that was generated by the radiology experts, and M(x) denotes the result of the application of the CNN to the first medical input image x. Alternatively, other loss functions may also be used, such as weighted binary cross-entropy, focal loss, or Dice loss.

On the basis of the validation set of 80 data sets and the corresponding annotations, the model with the best performance capability was selected from a plurality of machine learning models (with different hyperparameters, for example, number of layers, size and number of kernels, padding, etc.). The specificity and sensitivity were specified on the basis of the test set, the 100 data sets and the corresponding annotations.

In the foregoing description, independent of the grammatical term usage, individuals with male, female or other gender identities are included within the term.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method for noise reduction in input image data generated by an imaging system, the computer-implemented method comprising:
generating, via application of a first noise reduction algorithm, first noise-reduced image data based on the input image data, wherein the first noise-reduced image data comprises a first noise-reduced image point value for each image point of a plurality of image points, and wherein the application of the first noise reduction algorithm involves an application of a machine learning model to input data dependent upon the input image data;
checking an image content of the input image data according to a predetermined checking rule; and
generating resultant image data based on the input image data, wherein the resultant image data for each image point of the plurality of image points has a resultant image point value, wherein each resultant image point value is given by a combination, dependent upon a result of the checking, of the respective first noise-reduced image point value and a respective further image point value that is dependent upon the input image data.

2. The computer-implemented method of claim 1, further comprising:
generating, via application of a second noise reduction algorithm, second noise-reduced image data based on the input image data, wherein the second noise-reduced image data comprises a second noise-reduced image point value for each image point of the plurality of image points; and
providing each further image point value by the respective second noise-reduced image point value.

3. The computer-implemented method of claim 1, wherein the machine learning model contains a convolutional neural network.

4. The computer-implemented method of claim 1, further comprising:
generating, by applying a variance-stabilizing transformation based on the input image data, variance-stabilized input image data,
wherein the input data is dependent upon the variance-stabilized input image data.

5. The computer-implemented method of claim 4, wherein, in accordance with the predetermined checking rule, the checking of the image content is carried out dependent upon the variance-stabilized input image data, and
wherein the respective further image point value is dependent upon the variance-stabilized input image data.

6. The computer-implemented method of claim 1, wherein the input image data comprises an individual image dataset and a further individual image dataset,
wherein the individual image dataset and the further individual image dataset follow one another temporally, and
wherein, according to the predetermined checking rule, the image content is checked dependent upon the individual image dataset and the further individual image dataset.

7. The computer-implemented method of claim 6, further comprising:
determining, for each image point of the plurality of image points, a deviation value for a deviation of the individual image dataset from the further individual image dataset,
wherein the combination is dependent upon the respective deviation value.

8. The computer-implemented method of claim 7, wherein, in the determining of the respective deviation value, a difference dataset is determined from the individual image dataset and the further individual image dataset,
wherein, for each image point of the plurality of image points, a variance is established dependent upon the difference dataset, and
wherein the respective deviation value depends upon the respective variance.

9. The computer-implemented method of claim 1, wherein the combination for each image point of the plurality of image points depends upon a weighted sum of the respective first noise-reduced image point value and of the respective further image point value, and
wherein at least one weighting factor of the weighted sum depends upon the result of the checking.

10. The computer-implemented method of claim 9, further comprising:
determining, for each image point of the plurality of image points, a deviation value for a deviation of an individual image dataset from a further individual image dataset of the input image data,
wherein the at least one weighting factor is dependent upon the deviation value.

11. The computer-implemented method of claim 1, wherein the imaging system is a medical imaging system.

12. The computer-implemented method of claim 1, further comprising:
generating the input image data by the imaging system.

13. An imaging apparatus comprising:
a data processing system configured to:
generate, via application of a first noise reduction algorithm, first noise-reduced image data based on input image data, wherein the first noise-reduced image data comprises a first noise-reduced image point value for each image point of a plurality of image points, and wherein the application of the first noise reduction algorithm involves an application of a machine learning model to input data dependent upon the input image data;
check an image content of the input image data according to a predetermined checking rule; and
generate resultant image data based on the input image data, wherein the resultant image data for each image point of the plurality of image points has a resultant image point value, wherein each resultant image point value is given by a combination, dependent upon a result of the checking, of the respective first noise-reduced image point value and a respective further image point value that is dependent upon the input image data.

14. The imaging apparatus of claim 13, further comprising:
an imaging system configured to generate the input image data.

15. A non-transitory computer readable medium having a computer program product having program code that, on execution by a data processing system, cause the data processing system to:
generate, via application of a first noise reduction algorithm, first noise-reduced image data based on the input image data, wherein the first noise-reduced image data comprises a first noise-reduced image point value for each image point of a plurality of image points, and wherein the application of the first noise reduction algorithm involves an application of a machine learning model to input data dependent upon the input image data;
check an image content of the input image data according to a predetermined checking rule; and
generate resultant image data based on the input image data, wherein the resultant image data for each image point of the plurality of image points has a resultant image point value, wherein each resultant image point value is given by a combination, dependent upon a result of the checking, of the respective first noise-reduced image point value and a respective further image point value that is dependent upon the input image data.

16. The non-transitory computer readable medium of claim 15, wherein the program code, on the execution by the data processing system, is further configured to cause the data processing system to:
generate the input image data by an imaging system.
